(19) United States
(12) Patent Application Publication
(10) Pub. No.: US 2011/0262608 A1
(43) Pub. Date: Oct. 27, 2011

(54) Method and device for producing a product by microgelling and/or microparticulation of a preparation

(76) Inventor: Martin Burger, Stuttgart (DE)

(21) Appl. No.: 13/140,882

(22) PCT Filed: Dec. 21, 2009
(86) PCT No.: PCT/DE2009/001780

§ 371 Date: Jul. 11, 2011

(30) Foreign Application Priority Data
Dec. 22, 2008 (DE) 10 2008 064 203.7

(51) Int. Cl. A23P 1/10; A23J 3/08

(52) U.S. Cl. 426/490; 426/518; 99/453; 99/459

(57) ABSTRACT

A method for producing a product by microgelling and/or microparticulation of a preparation 4-containing whey proteins and a device for carrying out the method is provided. The method includes the preparation in a tank, and supplying the preparation 4 to a dispersal device. Shearing forces are constantly produced in the dispersal device which includes a rotating rotor for engaging in a stator. Direct vapour heating of the product, by way of a direct vapour heating unit at the dispersal device, to a temperature between 60 and 100 degrees Celsius occurs before discharge of microgelled and microparticulated product from the dispersal device.

The invention relates to a method for producing a product by microgelling and/or microparticulation of a preparation containing whey proteins, in particular microparticulation of filtration residues and a device for carrying out the method.

There is carried out combined thermal and mechanical processing and optionally additional thermal processing of protein concentrates such as, for example, filtration residues, in particular whey proteins in ultrafiltration whey concentrates.

An object of microparticulation is to produce filtration residues such as, for example, whey protein particles in a size range of a few micrometres. This is achieved by a combination of thermally induced denaturation and aggregation of the whey proteins with continuous mechanical processing such as, for example, shearing of the particles. Therefore, use is made of superimposition of the two counter-acting operations of aggregation and particle separation for the particulation process in order to obtain a specific size distribution of the particles.

The filtration residue, that is to say, for example, a whey protein aggregate, can be adapted to the specific requirements for different types of product by microparticulation. For example, whey proteins in the form of aggregates in the size range of a few micrometres can be integrated in a cheese matrix. When the method is used to produce cheese, for example, the product yield from the raw dairy product is increased and the texture properties, in particular of reduced-fat cheeses as a product, are improved.

When fresh cheese is produced, it is also possible to achieve a substantial increase in yield. The aggregates obtained by microparticulation in a specific size range, which is as narrow as possible, can also be used, for example, in a similar manner in the production of milk-based desserts or ice cream. In those products, the sugar content of the solution to be processed is particularly important to the formation of the gel. A field of application for products having natural or only slightly increased whey protein values also involves use as a replacement for conventional yoghurt milk heating or vat milk heating for, for example, quark or curd cheese.

A device for microparticulation is known, for example, from the published dissertation “Thermische Denaturierung und Aggregation von Molkenproteinen in Ultrafiltrations-molkenkonzentraten—Reaktionskinetik und Partikulieren im Schabewärmetauscher-” (Thermal denaturation and aggregation of whey proteins in ultrafiltration whey concentrates—reaction kinetics and particulation in scraper type heat exchanger), which appeared in Shaker Verlag under ISBN 3-8265-6233-X in 1999.

In the device for microparticulation previously known from this published dissertation, both the thermal processing operation and the operation involving mechanical processing, that is to say, mechanical comminution, of the particles are carried out in one and the same device at the same time in a coupled manner. There is used a scraper type heat exchanger, in which whey proteins from an ultrafiltration whey concentrate are introduced. In the scraper type heat exchanger, the ultrafiltration whey concentrate is heated, on the one hand, by a thermal transfer at a heat transfer surface, that is to say, a heat exchanger, of the scraper type heat exchanger. On the other hand, scrapers which rotate within the scraper type heat exchanger produce a shearing force, whereby mechanical comminution of the particles from the ultrafiltration whey concentrate is achieved. Scraper type heat exchangers are also physically limited in terms of the shearing rate.

In scraper type heat exchangers for microparticulation, the process of heating by means of which a formation of an aggregate of the particles is brought about is directly coupled to the operation of mechanical comminution of the particles. For instance, the heat transfer to the filtration residue can be varied only by the rotation frequency of the scrapers being increased which unavoidably, however, also leads to a change in the mechanical comminution effect. Consequently, the opposing operations of the aggregation brought about by thermal processing and the comminution brought about by mechanical shearing loads cannot be influenced as independent parameters of the process. This has the disadvantage that it is only possible in a limited manner in scraper type heat exchangers to produce particles in a preselected and narrow size range. In order to produce particles in particularly small size ranges of a few micrometres, the rotor has to be operated with the scrapers at a very high rotation speed. This has the disadvantage that the wear of the scraper type heat exchanger is particularly high. Operation at high rotation speeds further results in increased energy consumption. Known installations further have a very high volume so that heating and denaturation typically result in times during which the product is kept hot of between 30 seconds and 120 seconds owing to the different heating and agglomeration times.

In order to improve the microparticulation, WO 2006/024395 A1 proposes conveying the product through a homogeniser in a device for microparticulation of filtration residues with a scraper type heat exchanger after passage through the scraper type heat exchanger, and consequently to carry out an additional mechanical processing operation on the product that is independent of the scraper type heat exchanger. However, complete separation of the mechanical and thermal processing is not thereby achieved because those two processing operations are not separate in the scraper type heat exchanger.

An object of the invention is to provide a method and a device which are for producing a product, that is to say, a milk product, by microgelling and/or microparticulation of a preparation and which avoid disadvantages of the prior art, it particularly being intended to be possible to have a particularly high yield of particles with a high water binding capacity and creamy properties of the product in a manner conserving resources in microgelling which comprises mechanical processing and thermal processing and/or microparticulation of recipes which are based on filtration residues, in particular whey proteins in ultrafiltration whey concentrates.

This object is achieved by the method and device according to the claims. The dependent claims set out preferred embodiments of the invention.

In the method according to the invention (microparticulation method) for producing a product by microgelling and/or microparticulation of a preparation containing whey proteins, the following method steps are carried out:
provision of the preparation, for example, in a tank or directly as a filter residue from a microfiltration installation,
supply of the preparation, for example, from the tank, to a dispersal device (dispersion device), with shearing forces for mechanically processing the preparation being produced, preferably constantly, in the dispersal device having a rotating rotor which engages in a stator and
discharge of the microgelled and microparticulated product from the dispersal device. The preparation processed in the dispersal device, that is to say, the preparation after it has been processed in the dispersal device, is referred to as the product.

In particular, direct vapour heating of the product is carried out by means of the dispersal device. Dilution of the product of between one and three percent by volume with respect to the preparation may be produced by the water vapour introduced into the product or the preparation during the direct vapour heating.

According to the invention, therefore, shearing of the particles in the preparation is brought about by the rotor/stator arrangement and therefore there is carried out mechanical processing, that is to say, comminution and/or stretching, of the particles. Such a dispersal device operates with high shearing rates.

By the rotor engaging in the stator, the preparation is pressed through at least one gap, preferably with a gap width in the range of a few millimetres, that is to say, for example, from 1 to 5 millimetres.

The process is preferably carried out at temperatures of from 60° C. to 100° C.

In order to substantially exclude phage problems, the temperature is kept in the range above 90° C. when the microparticulate is used, that is to say, the product produced by the method according to the invention, in products to be acidified.

The term preparation containing whey proteins is intended to be understood to be a preparation in which a substantial amount, that is to say, a sufficient concentration, of whey proteins is present. A recipe, that is to say, an admixture of ingredients, is intended to be understood by the term preparation.

In the method for microgelling and/or microparticulation according to the invention, therefore, a mechanical processing device which is in the form of a dispersal device having a rotor and stator is used.

The dispersal zone formed in the region of the rotor is generally simply sufficient and multiple-step dispersal heads may be advantageous for special products. Practically any comminution of the particles in the preparation may be carried out by means of the rotor/stator arrangement. Thermal processing which is independent of the mechanical processing operation, that is to say, which can be controlled independently, is carried out by the direct vapour heating. Vapour which is preferably obtained from a milk product is directly introduced (injected) into the product. It is thereby possible to achieve very rapid and complete heating of the product in order to adjust the sizes of the particles in the product by agglomeration processes.

Direct vapour heating results in the entire amount of product being heated at the same time and the product not being thermally loaded to a greater extent at the surface of a heat exchange, as in indirect heating methods, than the product at the pipe centre. This advantageously results in a better yield and less variation of the particle size.

The dwell time characteristics of the method according to the invention are unique in comparison with methods known from the prior art. Owing to the simultaneous heating of the entire milk flow and not only of the part-flow conveyed along the outer wall of the heat exchanger, the temperature can be adjusted in a substantially wider range than in the known methods with a heat exchanger. Scorching of the product is impossible. Consequently, there may be produced particles which, particularly when incorporated in cheese, do not negatively influence the ability thereof to be cut. This is a substantial problem in comprehensive use of microparticles according to the prior art. The bandwidth of the concentration of whey proteins in the initial substance, that is to say, the preparation to be microgelled and/or to be microparticulated with the method according to the invention, can vary from 1.5% to 30% (percent by weight) in the method according to the invention, in particular preparations having more than 5% by weight of whey proteins can be processed. That is to say, a substantially greater range of preparations can be processed according to the invention than with previously known methods.

In order to develop the invention, the injected vapour is optionally produced with an indirect vapour generator comprising RO permeate of an RO integrated in the filtration installation of the protein concentrate or another prepared water. The indirect vapour may advantageously allow use in operations in which the vapour is generated in such a manner that the vapour may not or is not intended to be injected directly into foodstuffs.

The method according to the invention is particularly economical in terms of energy and a device for carrying out the method according to the invention operates in a particularly low-wear manner. The method according to the invention can be carried out in a device having a very small system volume, whereby start-up and shut-down losses when carrying out the method according to the invention can be greatly reduced over existing methods. The system volume may be only approximately 20% of the system volume of known comparable systems. Owing to the small system volume, the method according to the invention is also particularly suitable for charge-related start-stop operation, for example, in the case of addition to cheese finishing agents or in the ice cream industry. The microparticles can, for example, be produced individually during the preparation of various whey protein contents in the raw material and various heating and shearing parameters so as to be optimised in terms of the recipe.

According to the invention, a method without a scraper type heat exchanger with substantially higher shearing rates than the methods known in the prior art is proposed for microparticulation. It is thereby possible to produce not only microparticulated filtration residues but also microgels of all types based on whey proteins. The microgels can be produced both on the basis of the interactions of whey proteins, whey proteins and sugars and whey proteins and casein. The use of the method is suitable for a substantially greater bandwidth of concentrations of whey proteins in the preparation and can also be used for processing finished product recipes in place of intermediate products. The representative shearing rate of the known processes with a scraper type heat exchanger is in a bandwidth of from 500/s to 3000/s. With the dispersal device used in the method according to the invention with a rotor/stator system, it is possible to achieve shearing rates of from 500/s to 5,000,000/s, that is to say, in particular shearing rates of over from 3000/s to 5,000,000/s. Therefore, the range of achievable gel characteristics, the operating temperature and the concentrations in the initial substance vary more widely in a non-constant manner than in all previously known methods.

The preparation preferably passes through a heat exchanger between the tank and the dispersal device, in particular for preheating to a temperature between 70 and 90 degrees Celsius, and/or a homogeniser.

An additional thermal processing device, that is to say, the heat exchanger, is arranged upstream of the mechanical processing device. In a first step, an aggregation of the whey proteins in the preparation is thereby brought about. Only after that aggregation operation has been concluded is the mechanical comminution of the aggregates carried out under very precise parameters which may be selected independently of the heating operation.

The product may advantageously pass through a heat exchanger and/or a cooler after being discharged from the dispersal device. The product may be kept hot after passing through the dispersal device by the heat exchanger.

In the microparticulation method according to the invention, therefore, there may further be carried out a heat exchange between the preparation, for example, the filtration residue contained therein, and an end product of the microparticulation if the two heat exchangers mentioned are in the form of counter-current heat exchangers.

The heat exchanger may be provided as a plate heat exchanger for heat exchange between the filtration residues at the end product of the microparticulation. Owing to that variant which is particularly advantageous in terms of energy, the filtration residue is already preheated before being introduced into the dispersal device or another thermal processing device, at the same time the end product of the microparticulation further being able to be cooled. In particular, it is advantageously ensured that no other aggregation operations are carried out in an undesirable manner in the end product.

After the product has been conveyed out of the dispersal device, hot-filling of the product may be carried out for specific products, for example, for ricotta production. The heated temperature may be maintained with or without the product being returned to the dispersal device.

In particular in the case of production of an intermediate product which is intended to be further processed as a product of the method according to the invention, the product can be supplied in-line without cooling to another intermediate product, for example, dairy milk. In the case of production of a highly viscous product, it may also be advantageous to carry out filling in the hot state without cooling or with only slight cooling of the product after discharge from the dispersal device. The product may also be conveyed to a spray dryer or a flash cooling unit directly after it is discharged from the dispersal device.

The preparation very advantageously passes through a supply pump upstream of the dispersal device and the product downstream of the dispersal device passes through a discharge pump, a pressure difference being adjusted by means of the rate of the supply pump and discharge pump.

A system, that is to say, device, for carrying out the method according to the invention can be regulated substantially precisely by means of three parameters. The shearing of the product can be optimised by adjusting the rate of the rotor. The temperature adjustment can be ensured in an extremely precise manner by means of a vapour regulation valve of the direct vapour heating. It is possible to adjust the pressure in the mixing zone or in the shearing zone precisely owing to the pressure difference over the system, adjustable by means of the rate of the supply pump and discharge pump.

By the pressure difference being adjusted precisely, scorching of the product is prevented with the result that, inter alia, the possible operating period between two cleaning operations is optimised. Furthermore, particularly temperature programmes with relatively powerful heating generally require a higher pressure difference than protective heating methods.

The method according to the invention is particularly suitable for the microparticulation of the preparation if the preparation contains or comprises a filtration residue, in particular an ultrafiltration whey concentrate based on whey proteins. Such filtration residues can thus be added in particular to milk products without any loss of quality, or milk products may be completely produced therefrom.

In the method for microparticulation according to the invention, the filtration residues, in particular whey proteins in ultrafiltration whey concentrates, are subjected to mechanical processing and thermal processing (thermisation process), the thermal processing and the mechanical processing being carried out practically simultaneously in spatial and temporal terms in a manner limited to a narrow window of time. Adjustment of the parameters for shearing during the mechanical processing operation and that of the thermisation process are carried out absolutely independently of each other.

A device (microparticulation device) according to the invention for carrying out the method according to the invention for producing a product by microgelling and/or microparticulation of a preparation containing whey proteins has:
a tank for providing the preparation,
a dispersal device and a piping system for conveying the preparation from the tank into the dispersal device, the dispersal device having a dispersal chamber having a rotor and a stator, in such a manner that shearing forces for mechanically processing the preparation can be generated, preferably constantly, in the dispersal device with the rotating rotor which engages in a stator,
direct vapour heating of the product preferably being provided, with the dispersal device preferably having a vapour supply system, which is preferably separate from a preparation supply system, for direct vapour heating of the product, and
a discharge system for discharging the microgelled and microparticulated product from the dispersal device.

An adjustment device for adjusting a vapour flow of the direct vapour heating is preferably provided, it being possible to carry out controlled temperature adjustment of the direct vapour heating of the product by the adjustment. Therefore, the adjustment device adjusts the vapour flow and allows controlled temperature adjustment.

In the microparticulation device according to the invention, the thermal processing device may be in the form of a direct vapour heating unit on the dispersal device. In the dispersal device, a rotating rotor which engages in a stator constantly produces shearing forces. Optimum heating without any formation of preparation, that is to say, deposits in the dispersal device, is ensured owing to separate vapour and product supply in such a manner that mixing and therefore heating is carried out directly in the region upstream of the shearing zone. Direct vapour heating constitutes a thermal processing device of the preparation or product. This advantageously results in a very effective transfer of heat with a low thermal load, in particular of sensitive products, and substantially improved service-lives over devices which correspond to the current prior art.

In that manner, there is provided in the device according to the invention for mechanically processing and thermally processing comprising microparticulation of filtration residues, in particular whey proteins in ultrafiltration whey concentrates, a separate adjustable thermal processing device and a separate regulable mechanical processing device in a combined device, that is to say, in the dispersal device with direct vapour heating. It is thereby advantageously possible to vary both the heating and the mechanical processing selectively as mutually independent parameters. It is thereby possible to produce a desired size range of particles in a precise manner. The yield of particles within the optimum particle size range is consequently improved in an advantageous manner. In that a separate mechanical processing device is provided, a desired particle size distribution may be preselected over a larger range than in the prior art. It is further advantageous that expensive system components such as scraper type heat exchangers or homogenisers may be dispensed with. This allows lower investment and operating costs with increased quality, but also reduced maintenance times and lower maintenance costs.

In a specific construction of the invention, the rotor and/or the stator has/have a passage in the range of a few millimetres. This has the advantage that it is ensured that any filtration residue which has travelled through the device has a maximum particle size predetermined by the width of the passage and the shearing.

In order to allow a particularly wide range of applications for the microparticulation device according to the invention, there is provision for the gap width of the passage to be constructed so as to be variably adjustable by different inserts. With the characteristics mentioned relating to the particle size selection being retained, it is thereby advantageously possible for the mean value of a narrow particle size distribution to be displaceable as desired over a range, in particular for different products, which is set out by the gap width being adjusted. The device according to the invention can thereby be advantageously adapted to the processing of filtration residues for extremely different applications, whereby the efficiency is advantageously influenced. For instance, it is possible on the same system, for example, for bactofugate to be heated, ricotta to be produced, low-fat ice cream or yoghurt recipes to be heated or microparticulate to be produced.

A heat exchanger and/or a homogeniser is/are advantageously provided in the piping system between the tank and the dispersal device, whereby homogenisation of any fat portions of the preparation is possible before being supplied to the dispersal device. This method is particularly advantageous in the ice cream/yoghurt dessert sector. However, it is not absolutely necessary to have homogenisation if it is prohibited, such as in the case of bio-products.

In accordance with the product to be produced, it may be advantageous if a heat exchanger and/or a cooler is/are provided in the discharge system. The cooler can be used both as a precooler and as a deep-freeze. In the first case, the product is immediately further processed and, in the second case, the product is stored intermediately for a relatively long period of time for further processing. The product produced in the device according to the invention, that is to say, the microgel/microparticulate, can be supplied in-line to an intermediate product such as, for example, dairy milk, without cooling when the product is used as an intermediate product. Highly viscous products can be filled in the hot state with only slight cooling or without any cooling after production by the method according to the invention.

In a very advantageous manner, there is provided a supply pump in the piping system upstream of the dispersal device and a discharge pump in the discharge system downstream of the dispersal device, a pressure difference being adjustable by means of the rate of the supply pump and discharge pump. The pumps for supply and discharge may be constructed irrespective of the viscosity of the products to be produced as centrifugal pumps or positive-displacement pumps.

The discharge system preferably has a pipe loop arrangement and/or recirculation is provided, there being provided a connection from the discharge system to the piping system between the tank and the dispersal device. A dwell section which has a homogeneous dwell time range and through which the product must travel is produced by the pipe loop arrangement.

The microparticulation device according to the invention can be adapted to specific products if such a dwell section is arranged downstream of the thermal processing device and the mechanical processing device or the product passes through the system several times by way of recirculation. In an advantageous manner, the aggregation operation can thereby be completely finished outside the dispersal device after the mechanical comminution has been carried out. Consequently, it is advantageously prevented that further aggregation takes place after the mechanical comminution has been carried out, which would corrupt the desired size distribution in an undesirable manner.

A particularly advantageous development of the microparticulation method according to the invention is obtained if the filtration residue is stored intermediately in the dwell section. Preferably in conjunction with recirculation, it is thereby advantageously possible for the product to be kept hot over a defined period of time at a temperature level after the device has been travelled through in order thus to conclude the aggregate formation for a proportion of the residue that is as high as possible.

The invention is explained in greater detail below with reference to embodiments with reference to the drawings, in which:

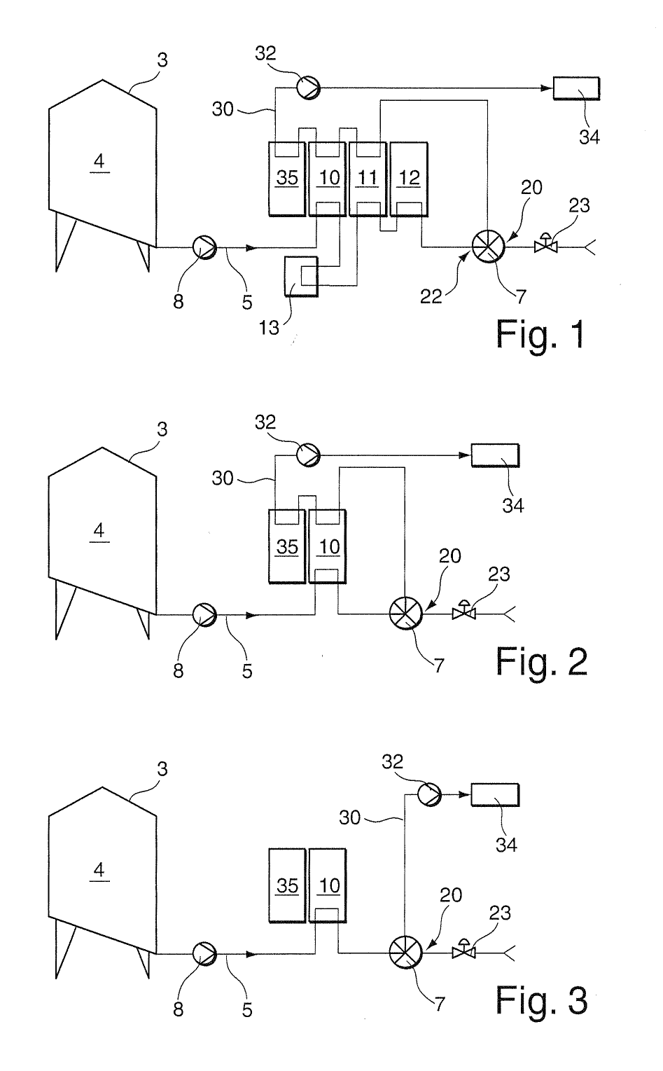

FIG. 1 is an illustration of the total construction of a microgelling/microparticulation device according to the invention.

FIG. 2 shows an embodiment of the microparticulation device according to the invention which is particularly suitable for cheese production.

FIG. 3 is an illustration of an embodiment of the microparticulation device according to the invention with hot-filling of the product.

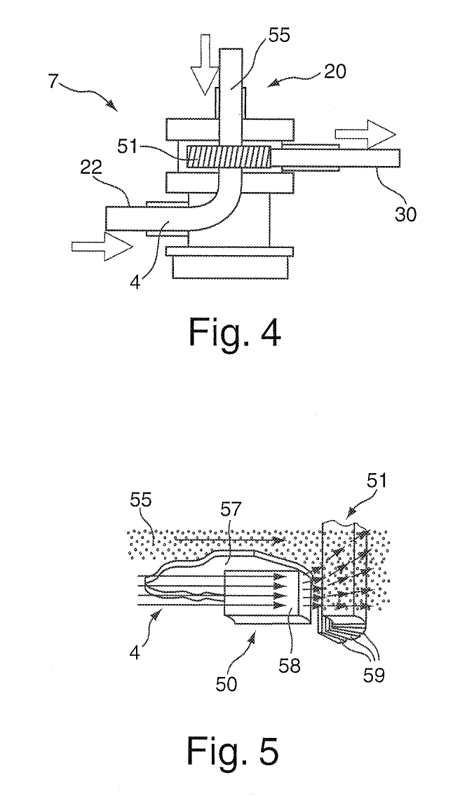

FIG. 4 is an illustration of a dispersal device used in the method according to the invention with direct vapour heating.

FIG. 5 is an illustration of how the rotor engages in the stator in the dispersal device according to FIG. 4.

The Figures of the drawings show the subject-matter according to the invention in a highly schematic manner and are not intended to be understood to be drawn to scale. The individual components of the subject-matter according to the invention are illustrated in such a manner that their construction can clearly be shown.

FIG. 1 is an illustration of the overall construction of a microgelling/microparticulation device according to the invention. A preparation 4 (feed) which contains whey proteins is provided in a tank 3. The preparation 4 is conveyed out of the tank 3 to a dispersal device 7 by a piping system 5. The preparation 4 passes through a supply pump 8. Between the supply pump 8 and the dispersal device 7 there are arranged in the piping system 5 two heat exchangers 10, 11, a heater 12 and a homogeniser 13, through which the preparation 4 also travels. The direction of flow of the preparation is indicated in the Figure by an arrowhead on the piping system 5.

The dispersal device 7 has a dispersal chamber having a rotor and a stator so that shearing forces are constantly produced on particles which are present in the preparation 4 in the dispersal device 7 with the rotating rotor which engages in a stator. The rotor and the stator are merely indicated in the Figure by intersecting lines in the dispersal device 7.

A direct vapour heating unit 20 is provided on the dispersal device 7. That device must be used only for production in the case of preparations having a relatively high concentration of whey proteins. The dispersal device 7 has a vapour supply, which is separate from a preparation supply 22, that is to say, an inlet opening for supplying the preparation 4 to the dispersal device 7, for direct vapour heating of the product. The vapour for operating the direct vapour heating 20 is supplied to the dispersal device 7 via a control valve 23.

There is provided a discharge system 30 for discharging the microgelled and microparticulated product from the dispersal device 7. There is provided in the discharge system 30 a discharge pump 32, by means of which the product is pumped to a destination 34. That destination 34 is in the form of, for example, a filling installation. The position of the discharge pump in the system is variable and dependent on the pressure drop of the heat exchangers. The position will ideally be directly downstream of the dispersal device with high pressure drops.

Two heat exchangers 10, 11 and a cooler 35 are arranged in the discharge system 30 between the dispersal device 7 and the discharge pump 32 and are passed through by the product. The heat exchangers 10, 11 are the heat exchangers 10, 11 which are also passed through by the preparation 4. The heat exchangers 10, 11 are operated with a counter-current method so that a heat exchange 10, 11 is brought about between the preparation 4 and the microparticulated product.

The feed is supplied from a tank 3 to the heat exchanger 10 by means of the supply pump 8. In the heat exchanger 10, the feed is preheated by means of the product already microparticulated/microgelled. Depending on the composition of the feed, homogenisation in the homogeniser 13 may be advantageous. Subsequently, the product is heated in the other heat exchanger 11 in counter-current to typically from 70 to 75° C. Depending on the composition of the feed, there is carried out heating to a shearing temperature in the heater 12 or directly in the dispersal device 7, that is to say, in the shearing chamber or dispersal chamber thereof, by means of direct vapour heating 20 via the control valve 23. The shearing produced in the feed in the dispersal device 7 brings about the microgelling/microparticulation of the preparation 4. As already set out, cooling of the product is carried out in counter-current in the heat exchangers 10, 11. If the product is not intended to be further processed in-line, it is typically cooled by means of the cooler 35. The discharge pump 32 is important. In the event of counter-pressure downstream of the dispersal device 7, the discharge pump 32 allows precise adjustment of the pressure in the dispersal chamber.

That process illustrated contains all the process steps or all the variants of the method according to the invention, only the necessary method steps always being selected in relation to specific applications. The important aspect is to pass through the dispersal device 7 and the direct vapour heating unit 20.

FIG. 2 illustrates an embodiment of the microparticulation device according to the invention which is particularly suitable for cheese production. Unlike the device according to the invention in accordance with FIG. 1, in this embodiment only one heat exchanger 10 is passed through using the counter-current method. After the heat exchanger 10 is passed through, the product passes through a cooler 35. A heater is further not provided or the preparation is not preheated in a heater before passing through the dispersal device 7, and a homogeniser, and therefore homogenisation of the preparation, is not provided.

By a microparticulated WPC35-60 being added to the preparation, the dry mass in the cheese may be reduced by more than 2% and a substantially more creamy cheese produced. The position of the discharge pump in the system is variable and depends on the pressure drop of the heat exchangers. In the case of high pressure drops, this will ideally be directly downstream of the dispersal device. The adjustment of the temperature at the outlet can be carried out by means of the cooler/repeater 35 or by means of a bypass valve at the heat exchanger 10.

FIG. 3 illustrates an embodiment of the microparticulation device according to the invention with hot-filling of the product. The method is also suitable for directly loading spray dryers. Unlike the embodiments according to FIG. 1 and FIG. 2, the product does not pass through a cooler (at a maximum one minimal subsequent temperature control device). As in the embodiment according to FIG. 1, there is provision for the preparation 4 to pass through a heater 12 before it is supplied to the dispersal device 7. This variant of the method according to the invention is suitable, for example, for producing highly viscous products such as ricotta. The pump 32 is not necessary for all methods.

FIG. 4 illustrates a dispersal device 7 which is used in the method according to the invention and which has direct vapour heating 20. The direct vapour heating unit 20 is formed by an inlet, through which water vapour 55 is introduced into the dispersal device 7 in such a manner that it is urged through the stator 51 of the dispersal device 7 together with the preparation 4, which is introduced into the dispersal device 7 by a preparation supply 22, by means of the rotor of the dispersal device 7. The water vapour 55 condenses in the preparation 4 so that the product discharged from the dispersal device 7 into the discharge system 30 is slightly dilute in comparison with the preparation 4. The flow directions of the water vapour 55, the preparation 4 and the product are indicated in the Figure by means of arrows. Since the rotor is rotated within the stator 51, the rotor in the Figure is hidden by the stator 51 and is therefore not illustrated.

FIG. 5 illustrates how the rotor 50 in the dispersal device 7 according to FIG. 4 engages in the stator 51. In this instance, the flow directions of the water vapour 55, the preparation 4 and the product are also indicated by arrows. The rotor 50 is in the form of a plate 57 with a toothed ring 58 positioned thereon. The Figure only shows a portion of the rotor 50 with a tooth 58. The axis of rotation of the rotor 50 extends vertically from the plane of the drawing. The stator 51 has gaps 59, through which the preparation water vapour mixture is pumped by the rotor 50.

There is proposed a method for producing a product by microgelling and/or microparticulation of a preparation 4 containing whey proteins and a device for carrying out the method. The method has the following method steps:
provision of the preparation 4, preferably in a tank 3,
supply of the preparation 4 to a dispersal device 7, shearing forces being constantly produced in the dispersal device 7 with a rotating rotor which engages in a stator,
direct vapour heating 20 of the product, preferably by means of a direct vapour heating unit 20 at the dispersal device 7, preferably to a temperature between 60 and 100 degrees Celsius, and
discharge of the microgelled and microparticulated product from the dispersal device 7.

The invention is not limited to the embodiments set out above. Instead, a number of variants are conceivable and also make use of the features of the invention with a construction which is of a different type in principle.

1. (canceled)

2. Method according to claim 16 wherein shearing rates of from 500/s to 5,000,000/s, are produced by the rotating rotor which engages in the stator.

3. Method according to claim 16 wherein the preparation is pressed through at least one gap having a gap width in the range of a few millimetres.

4. Method according to claim 16 wherein direct vapour heating of the product is carried out to a temperature between 60 and 100 degrees Celsius, with the direct vapour heating being provided on the dispersal device.

5. Method according to claim 4, wherein dilution of the product of between one and twenty percent by volume with respect to the preparation is produced by the direct vapour heating.

6. Method according claim 16 wherein the preparation passes through a heat exchanger before being supplied to the dispersal device, for preheating to a temperature between 70 and 90 degrees Celsius, and/or a homogeniser.

7. Method according claim 16 wherein after the product has been conveyed out of the dispersal device, hot-filling of the product is carried out, with maintenance of the heated temperature and/or spray-drying being carried out directly.

8. Method according to claim 16 wherein the preparation passes through a supply pump upstream of the dispersal device and the product downstream of the dispersal device passes through a discharge pump, a pressure difference being adjusted by means of a rate of the supply pump and discharge pump.

9. Method according to claim 16 wherein the preparation comprises an ultrafiltration whey concentrate containing whey proteins.

10. Device for carrying out the method according to claim 16, the device comprising: a dispersal device and a piping system for conveying the preparation from a tank into the dispersal device, the dispersal device having a dispersal chamber having a rotor and constant stator for mechanically processing the preparation in the dispersal device with the rotating rotor engaging a stator; a direct vapour heater having a vapour supply system, separate from a preparation supply system, for direct vapour heating of the product, and
a discharge system (30) for discharging the microgelled and microparticulated product from the dispersal device (7).

11. Device according to claim 10, wherein an adjustment device for adjusting a vapour flow of the direct vapour heating is provided, in order to carry out controlled temperature adjustment of the direct vapour heating of the product by the adjustment.

12. Device according to claim 10 wherein a heat exchanger and/or a homogeniser is/are provided in the piping system between the tank and the dispersal device.

13. Device according to claim 10 wherein a heat exchanger and/or a cooler is/are provided in the discharge system.

14. Device according to claim 10 wherein there is provided a supply pump in the piping system upstream of the dispersal device and a discharge pump in the discharge system downstream of the dispersal device, a pressure difference being adjustable by means of the rate of the supply pump and discharge pump.

15. Device according to claim 10 wherein the discharge system has a pipe loop arrangement and/or in that recirculation is provided, and a connection from the discharge system to the piping system is provided between the tank and the dispersal device.

16. A method for microgelling/microparticulation, the method comprising:
supplying a preparation containing from 1.5 to 30 by weight whey proteins, to a disposed device producing constant sharing forces with a rotating rotor engaging a stator; and
discharging a microgelled and microparticulation product for the dispersal device.
